(19) United States
(12) Patent Application Publication
(10) Pub. No.: US 2004/0033419 A1
(43) Pub. Date: Feb. 19, 2004

(54) Negative active material, negative electrode using the same, non-aqueous electrolyte battery using the same, and method for preparing the same

(76) Inventor: Atsushi Funabiki, Kyoto-shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/461,187

(22) Filed: Jun. 13, 2003

(30) Foreign Application Priority Data
Jun. 14, 2002 (JP) P.2002-174887

(51) Int. Cl. H01M 4/58; H01M 4/62; C01B 33/20

(52) U.S. Cl. 429/218.1; 429/232; 423/326

(57) ABSTRACT

A non-aqueous electrolyte battery using a negative active material which is characterized by comprising Si and O at the atomic ratio of O to Si, x, being 0<x<2, and by showing a full width at half maximum of Si(220) plane peak, B, being B<3 degree (2 θ) at x-ray diffraction with CuKα radiation shows better cycle performance.

### BACKGROUND OF THE INVENTION

1. Field of the Invention

This invention is in the field of a negative active material, preparation of the material thereof, a negative electrode using the material, and a non-aqueous electrolyte battery comprising the negative active material.

2. Description of the Related Art

Recently, a high-energy-density non-aqueous electrolyte battery has been widely used as power sources for such as cellular phone, PDA, digital camera and other applications. Due to the trend of the progress for cordless electronic devices, the demand of a non-aqueous electrolyte battery is expected to be much greater.

Currently, graphite and lithium-transition-metal oxide are commonly used as negative and positive active materials for non-aqueous electrolyte battery, respectively. Its energy density, however, is considered to be not enough for the next-generation electronic devices. Recently, it has been intensively studied to increase the discharge capacity of negative and positive active materials to increase the energy density of the battery. For negative active material, lithium alloy, which gives higher discharge capacity than graphite, has attracted much intention. The use of lithium alloy as negative active material, however, causes a significant volume change of negative active material during charge and discharge. This results in loosing electrical-conductive network between the active materials, which brings large decrease in discharge capacity of the negative electrode with cycling. On the other hand, when using a metal, which forms alloy with lithium, such as silicon, tin, aluminum, lead, zinc etc., and using oxide of these metals as the negative active material for non-aqueous electrolyte battery, the oxide of the metals mentioned above was reported to show better cycle performance than the metals themselves. (N. Li, C. R. Martin, and B. Scrosati, Electrochemical and Solid-State Letters, 3, 316 (2000)). Silicon oxide, among those oxides, is very attractive as a negative active material for lithium secondary batteries because of its large discharge capacity and relatively low discharge potential. (Japan Patent 2997741, and Abstract of the 38th Battery Symposium in Japan, page 179 (1997)). It was reported that the energy density and safety of the battery using silicon oxide as a negative active material were improved by coating an electrically-conductive material such as carbon on the surface of the oxide. (Unexamined Japanese Patent Application 2002-42806). The cycle performance of the battery using silicon oxide as a negative active material is, however, still below that using graphite.

Then, the inventor of this patent focused on the crystalline structure of silicon oxide. As a result, it was found that the battery using a material which was phase-separated into silicon and its oxide, of which chemical formula was expressed as SiOₓ (O<x<2), showed extremely improved cycle performance. This material is prepared, for instance, by a method such as heat-treatment of SiO under a non-oxidizing atmosphere at a temperature of higher than 800° C. (Iwanami Rikagakujiten (Physical and Chemical Dictionary) 4th Edition, Iwanami Publishing Co., Tokyo, page 495 (1987)). And, any report has not been published on using the mentioned phase-separated material for the negative active material of non-aqueous electrolyte battery.

### BRIEF SUMMARY OF THE INVENTION

As explained above, there has been a technical issue to improve the cycle performance of non-aqueous electrolyte battery using silicon oxide as a negative active material. The present invention is to resolve this problem.

The first invention is the invention of a negative active material, which is characterized by using a material containing Si and O at the atomic ratio of O atom to Si atom, x, being 0<x<2, and showing a full width at half maximum of Si (220) plane peak, B, being B<3 degree (2 θ) at x-ray diffraction with CuKα radiation.

The second invention is a negative active material of the first invention, which is characterized by being attached on its surface with electrically-conductive material. The cycle performance of the battery is further improved by the second invention.

The third invention is the invention of the negative active material of the second invention, which is characterized by the electrically-conductive material being carbon (A). The third invention increases the discharge capacity of the battery.

The fourth invention is the invention of the negative electrode, which is characterized by containing a mixture of carbon (B) and the negative active material of the first, second, or third inventions. The fourth invention further improves the cycle performance of the battery.

The fifth invention is the invention of the negative electrode of the fourth invention, which is characterized by the amount of carbon (B) being in the range of 1 to 30% against the total mass of the negative active material mentioned above and of the carbon (B). According to the fifth invention, the cycle performance of the battery is further improved and its discharge capacity is further increased.

The sixth invention is the invention of the manufacturing method of the negative active material of this invention, which is characterized by heating a material containing Si and O, where x is the atomic ratio of O to Si and is expressed as 0<x<2, under non-oxidizing atmosphere at a temperature of higher than 830° C. The sixth invention provides very simple and superior manufacturing method of the negative active material of this invention.

The seventh invention is the invention of a non-aqueous electrolyte battery comprising a positive electrode allowing to store and release lithium ion, and a negative electrode using the negative active material mentioned above of the first, second, or third inventions, or comprising the negative electrode mentioned above of the fourth or fifth invention. The seventh invention provides a non-aqueous electrolyte battery with excellent cycle performance.

### BRIEF DESCRIPTION OF THE DRAWINGS

FIG. 1 shows x-ray diffraction pattern of the negative active material (e4) in the range of 10 degree to 70 degree (2 θ).

FIG. 2 shows an image of transmission electron microscope of the negative active material (e4).

### DETAILED DESCRIPTION OF THE INVENTION

Defining the atomic ratio of O to Si as x, a negative active material of this invention is expressed as SiOₓ (0<x<2) with showing a diffraction peak at 18-23 degrees (2 θ), 27-30 degrees (2 θ) and 46-49 degrees (2 θ), respectively, at x-ray diffraction with CuKα radiation. The peak at 18-23 degree is attributed to silicon oxide, and the peaks at 27-30 degree and 46-49 degree are attributed to Si (111) and Si (220) plane, respectively. Thus, the negative active material of this invention contains both phases of silicon oxide and silicon. And it is preferable for silicon to be dispersed as fine particle in the negative active material of this invention, and its particle diameter is preferably 3-30 nm. And, it is more preferably 5-20 nm. Silicon particle is preferably to be finely dispersed in the negative active material, rather than to be aggregated. The negative active material having silicon particle of being finely dispersed, compared with that having the aggregated one, provides better electrical conductivity between the negative active materials. Furthermore, a battery using the former negative active material shows improved cycle performance. Average particle diameter of silicon is calculated from 50 particles with a transmission electron microscope.

An observation method with a transmission electron microscope is then explained. A powdery sample is prepared from a negative active material of this invention and placed into a photo-resist material, which is then irradiated with argon ion to obtain a sample sheet of about 20 nm in thickness. The acceleration voltage and the incident angle of the ion irradiation is preferably kept at 3.0 kV and at less than 3 degree, respectively. For taking photographs, an acceleration voltage of more than 200 kV is preferably applied. More detailed study on the dispersed silicon particle can be achieved by elementary analysis on the individual particles and on the surroundings, and by two-dimensional mapping of element.

A full width at half maximum of Si (220) plane diffraction peak at 46-49 degree, B, for the negative active material of this invention is less than 3 degree. In this case, a relative intensity, (I₍₂₂₀₎/I₍₁₁₁₎), is preferably below 0.5, where I₍₂₂₀₎ and I₍₁₁₁₎ denote the intensity of the diffraction peaks of Si (220) plane and Si (111) plane, respectively. Further, a full width at half maximum of Si (111) plane diffraction peak is preferably less than 3 degree. The value, x, described above are derived from such measurements as nuclear magnetic resonance (NMR), elementary analysis, energy dispersive x-ray spectrometer (EDS), and so on.

A non-aqueous electrolyte battery using a negative active material where the value of B is not less than 3 degree gives very poor cycle performance than that using a negative active material of this invention. Accordingly, the value of B should be less than 3 degree. The cycle performance of the battery is further improved by keeping the range being 0.3<B<3 degree. Furthermore, the range of 0.8<B<2.3 degrees gives the more improved cycle performance. Thus, the preferable range of the value of B is 0.3<B<3 degrees, and its more preferred range is 0.8<B<2.3 degrees.

The negative active material of this invention shows a characteristic x-ray diffraction pattern as mentioned above, at least before assembling the material into a battery. However, an active material of this invention after being charged and discharged is not limited. That is, a negative active material of this invention taken from a battery after being charged and discharged may show no characteristic x-ray diffraction pattern mentioned above or may show another peak.

The negative active material of this invention, where its chemical formula is expressed as SiOₓ (0<x<2),gives a result of this invention, while x of too small number gives relatively poor cycle performance. A preferable chemical formula of the negative active material of this invention is SiOₓ (0.5<x<2), which gives excellent cycle performance.

Comparing the battery of this invention comprising the negative active material, the surface of which chemical formula was SiOₓ (1.5<x<2) and that of which chemical formula was SiOₓ (0<x<1.5), the latter battery showed a larger discharge capacity. The reason is that the latter negative active material has less amount of SiO₂ in its surface, and thus has higher electronic conductivity than the former one, resulting in improved utilization of the negative active material. Hence, the chemical formula in the surface of a negative active material of this invention is preferably expressed as SiOₓ (0<x<l.5). The value of x can be evaluated by x-ray photoelectron spectroscopy (XPS).

A shape of a negative active material of this invention may be sheet, thin film, particle, and fiber. Using the negative active material as particle, an average particle diameter, r (μm), is preferably r<10. This particle diameter is measured with a laser method after being dispersed in water at least for 15 second and preferably for longer than 10 minute using a ultrasonic equipment. The average particle diameter denoted here is calculated, based on the number of the particles counted by the laser.

Keeping the mentioned particle diameter being less than 10 μm causes a large improvement of the cycle performance of the battery of this invention. When the negative active material of this invention is used in a lithium secondary battery, an alloy is formed from the reaction between SiOₓ and Li during charge, which causes a volume expansion of SiOₓ. When the particle diameter of the negative active material is large, this expansion results in cracking and pulverization of the particle, and, then, losing electrical contact between the negative active materials, and thus, lowering the cycle performance of the battery. The extent of cracking and pulverization of lithium-alloy particle can be reduced by using the particle of smaller diameter according to the report of Martin Winter et al. (Electrochimica Acta, 31, 45 (1999)). However, a suitable particle diameter of the negative active material of this invention has not been clear. Inventor of this invention has studied extensively and found that keeping the average particle diameter being less than 10 μm brings remarkable improvement on the cycle performance of the battery using the negative active material of this invention.

When r is less than 5 (μm), the cycle performance of the battery is further improved. However, if r is less than 0.5 (μm), the battery requires large amount of electrically-conductive material, and thus results in the decrease of energy density of the battery. Thus, more favorable particle diameter is 0.5<r<5 (μm).

In addition, a negative active material of this invention is preferably attached with an electrically-conductive material on the partial or entire surface of the active material. Carbon material (A) or metal can be used as an electrically-conductive material. The metal is preferably selected from metals not to form alloy with lithium. Graphite and lower-crystalline carbon can be used as carbon (A), and one kind of metal selected from a group of copper, nickel, iron, cobalt, manganese, chromium, titanium, zirconium, vanadium, and niobium, or an alloy of more than two kinds of these metals can be used for the metal mentioned above. Among these electrically-conductive materials described above, carbon material is most preferable, because it can store and release lithium ion, leading to larger discharge capacity of the battery. And, a shape of the carbon (A) attached on the surface of a negative active material of this invention can be a thin film or particle.

A preferable amount of the metal as electrically-conductive material is in the range of 5-20% by mass against the total mass of the metal and the negative active material. This mass ratio of not less than 5% improves the cycle performance and increases the discharge capacity of the battery. This is because the mass ratio of not less than 5% allows sufficient electrical contact between the active materials. Furthermore, as long as the amount of the metal is not more than 20% by mass, the utilization of the active material increases as the amount of the metal increases, resulting in the increase of the discharge capacity of the battery. However, when the amount of the metal is more than 20% by mass, the discharge capacity of the battery decreases with the increase in the amount of the metal because the discharge capacity of the metal is negligibly small.

The negative active material having the mentioned electrically-conductive material on its surface can be prepared by such as mechanical mixing method, chemical vapor deposition (CVD) method, chemical or electrochemical plating method and a method using heat-treatment.

Methods to attach carbon on the surface of SiOₓ (0<x<2) are follows; Depositing carbon on the surface of SiOₓ (0<x<2) by CVD method from the pyrolysis of organic compounds such as benzene, toluene, or xylene in the gas-phase; pitch is coated on the partial or entire surface of SiOₓ (0<x<2) and then heating the resulting material; mixing of SiOₓ (0<x<2) and graphite powders, and then carbon is deposited by CVD method on the surface of the resulting agglomerated mixture; and mechanical method. As to the mechanical method, there may be a mechanical milling method, a mechano-fusion method, and a hybridization method.

A preferable amount of carbon (A) is in the range of 5-60% by mass against the total mass of the carbon (A) and of the negative active material of this invention, and the more favorable ratio is in the range of 15-25%. The amount of carbon (A) of not less than 5% by mass causes the improved cycle performance and the increased discharge capacity of the battery, because this condition gives sufficient electronic conductivity on the negative active material of this invention. The utilization of the negative active material of this invention remarkably increases when the amount of carbon(A) is in the range of 15-25% by mass, which significantly improves the discharge capacity of the battery. On the other hand, the discharge capacity of the battery decreases when the amount of carbon (A) is more than 60% by mass, because the discharge capacity of the carbon (A) is smaller than that of the negative active material of this invention.

SiOₓ (0<x<2) attached with carbon on its surface has been reported by Japanese Non-examined Patent (Publication No. 2002-42806). However, the preferable crystalline structure of SiOₓ (0<x<2) and the preferable amount of carbon on its surface were not described. The inventor of this invention has studied extensively, and found that the preferable crystalline structure is shown by the x-ray diffraction pattern mentioned above and that the preferable amount of carbon on the surface of SiOₓ (0<x<2) is in the range mentioned above.

The value of d (002), an average distance between graphene layers for carbon (A) attached on the surface of SiOₓ (0<x<2), is estimated by x-ray diffraction, and the cycle performance of the battery having the negative active material of this invention is remarkably improved when the value of d(002) is not more than 0.3600 nm. Accordingly, the preferable value of d(002) for carbon (A) is not more than 0.3600 nm. On the other hand, if the value of d(002) is more than 0.3600 nm, the cycle performance of the battery is not greatly improved. The Japanese Non-examined Patent (Publication No. 2002-42806) demonstrated on the crystallinity of carbon attached on the surface of SiOₓ (0<x<2), and mentioned that low crystallinity is preferable for the carbon. However, as mentioned above, high crystallinity is preferable for the carbon attached on the surface of the negative active material of this invention. The reason of this discrepancy has not been clearly understood. However, it is probable that SiOₓ (0<x<2) having the characteristic crystalline structure like this invention needs high-crystalline carbon on its surface in terms of delivering large discharge capacity. That is, the electronic conductivity of SiOₓ (0<x<2) without carbon on its surface is considered to be similar to that of the carbon having d (002) of more than 0.3600 nm, and thus the electronic conductivity of SiOₓ (0<x<2) attached with carbon on its surface could be increased when the value d(002) for the carbon is not more than 0.3600 nm.

The negative electrode of this invention contains a mixture of the negative active material of this invention and carbon (B). Using this negative electrode, the cycle performance of this battery is improved. This is probably because electrical conductivity between the negative active materials is improved by the addition of carbon (B).

Carbon (B) is preferably at least one kind of carbon selected from a group of natural graphite, artificial graphite, acetylene black, and vapor grown carbon fiber (VGCF). Using these carbons, the cycle performance of the battery is greatly improved. On the other hand, other carbons such as low-crystalline carbon and non-graphitizable carbon do not improve so much the cycle performance. This is probably because carbon (B) selected from a group of natural graphite, artificial graphite, acetylene black, and VGCF gives better electrical contact between the negative active material of this invention and the carbon (B) than the low-crystalline carbon and non-graphitizable carbon do.

Any known natural graphite, artificial graphite, acetylene black, and VGCF may be used for carbon (B). Among them, VGCF is most favorable, and it especially improves the cycle performance of the battery. This is probably because good electrical contact between the negative active material of this invention and the carbon fiber is maintained even under the expansion and shrinkage of the negative active material during charge and discharge.

The average diameter, r (μm), determined by the laser method as mentioned above and the specific surface area, S (m²/g), measured by the Brunauer, Emmett, and Teller (BET) method using N₂ gas, of natural graphite and artificial graphite are preferably 0.5<r<50 and 0.05<S<30, respectively. The average diameter and the specific surface area are more preferably 1<r<20 and 0.1<S<10, respectively. Keeping the average diameter and the specific surface area in these ranges suppresses the decomposition of electrolytic solution on the surface of the graphite, which reduces the irreversible capacity of the negative electrode and, thus increases the energy density of the battery.

Examples of artificial graphite include a material prepared from heating graphitizable carbon as cokes, and also include exfoliated graphite.

VGCF having large long-axis diameter may pass through a separator to cause short circuit between negative and positive active materials. Thus, its long-axis diameter is preferably shorter than the thickness of a separator. Since the thickness of a separator is normally about 20 μm the long-axis diameter of VGCF is preferably not longer than 20 μm.

The amount of carbon (B) of not less than 1% by mass against the total mass of the negative active material and the carbon (B) allows the improved cycle performance and the increased discharge capacity of the battery. This is probably because the electrical contact between the negative active materials is well maintained. On the other hand, when the amount of the carbon (B) is not less than 30% by mass, the discharge capacity of the battery decreases because the discharge capacity of the carbon (B) is less than that of the negative active material of this invention. Thus, considering the cycle performance and the discharge capacity, the amount of the carbon (B) is preferably not less than 1% by mass and not more than 30% by mass. In this case, the negative active material of this invention may or may not have electricallyconductive material on its surface. Here, the total mass of the negative active material of this invention and carbon (B) includes electrically-conductive material on the surface of the negative active material. Accordingly, ‘the total mass of the negative active material and of carbon (B)’ described in the claim of this invention includes the mass of electrically-conductive material on the surface of the negative active material.

Specific surface area, S (m²/g), of the negative active material of this invention, measured by the BET method is preferably less than 50 (m²/g), and more preferably S<10. In the case of S≧50, the decomposition of electrolyte on the surface of the negative active material is promoted, which results in the loss of electrolyte, and thus leads to poor cycle performance of the battery. In contrast, if S is less than 10, the amount of binder in the negative electrode can be decreased drastically, which brings the increase of the energy density of the battery.

An example of the production method of the negative active material of this invention is; SiOₓ (0<x<2) is heat-treated at temperature of higher than 830° C. under non-oxidizing atmosphere or reduced pressure. And, further, the product obtained in the above method is preferably treated with fluorine-containing material or aqueous alkaline solution. The subsequent treatment of the product decreases the amount of Sio₂ in the surface of the product, which results in the improvement of the electronic conductivity of the product. Further, this additional process increases the discharge capacity of the product as a negative active material. Examples of SiOₓ (0<x<2) to be used for the starting material include stoichiometrical materials such as SiO₁, SiO_{1.5} (Si₂O₃), and SiO_{1.33} (Si₃O₄), and any other material of SiOₓ where x is more than 0 and less than 2. Furthermore, a material containing Si and Sio₂ at any ratio may be used as long as the chemical formula of the material is expressed as SiOₓ (0<x<2). A gas to be used for non-oxidizing atmosphere is an inert gas such as nitrogen, herium, and argon, reducing gas such as hydrogen, and a mixture thereof. Examples of fluorine-containing material include hydrogen fluoride, ammonium bifluoride, and any materials which dissolve SiO₂. These materials may be in the form of solid, gas, or solution. An example of aqueous alkaline solution includes a solution dissolving hydroxide of alkali metal as Li, Na, and K or of alkaline earth metal as Mg and Ca. To promote the dissolution of SiO₂, the temperature of the aqueous alkaline solution is preferably of not lower than 40° C. It is preferable that the concentration of fluorine-containing material or aqueous alkaline solution is not too high. In addition, it is also preferable that a time for the reaction using the fluorine-containing material and aqueous alkaline solution is not too long. The reason is that too high concentration or too long reaction time results in promoting the dissolution of not only SiO₂ but also Si, which causes the severe decreasing of the amount of Si in the product. When using the product as negative active material, the decrease of the amount of Si leads to the decrease in the discharge capacity of the negative electrode and of the battery. Preferable concentration and reaction time are not more than 5 mol per 1 g of SiOₓ (0<x<2) and not longer than 24 hours, respectively, and more preferably not more than 0.5 mol per 1 g of SiOₓ (0<x<2) and not longer than 6 hours.

As mentioned above, the preparation method of the negative active material of this invention includes heat-treatment of SiOₓ (0<x<2) under non-oxidizing atmosphere or reduced pressure. Here, the reduced pressure is below 30 Torr, more preferably below 3 Torr, and most preferably below 0.3 Torr. Needless to say, however, even at the reduced pressure above 30 Torr, the effect of this invention is obtained.

During the preparation of the negative active material mentioned above, assuming the heat-treatment process as process 1, treatment with fluorine-containing material or alkaline solution as process 2, and a combination of process 1 and process 2 as a set, this set of operation may be repeated more than one time.

The improvement on the cycle performance of the battery is achieved by using the negative active material prepared by the heat-treatment of SiOₓ (0<x<2) at a temperature higher than 830° C. Thus, heat-treatment temperature, T, should be 830<T (° C.). The more preferable heat-treatment temperature is 900<T (° C.)<1150, because the negative active material prepared under this condition gives further improved cycle performance of the battery.

Treatment of SiOₓ (0<x<2) with hydrofluoric acid to obtain SiOₓ (x<1) was reported (Japanese Non-examined Patent Publication No. 2002-42809). However, this known document did not describe the preferable structure of SiOₓ (0<x<2) which gives the better cycle performance of the battery. The inventor of this invention, then, studied the electrochemical properties of various negative active materials with different crystaline structure where the chemical formula of the active materials are expressed as SiOₓ (0<x<2). It was found that the battery using the negative active material showing a characteristic x-ray diffraction pattern gives excellent cycle performance. This negative active material is, for example, prepared by the heat-treatment of SiOₓ (0<x<2) at a temperature T (830<T (° C.)) under non-oxidizing atmosphere or reduced pressure, and it is preferable that the product prepared by the foregoing process is subsequently treated with fluorine-containing material like hydrofluoric acid or with alkaline solution. Comparing the battery having SiOₓ (0<x<2) treated with fluorine-containing material and that having SiOₓ (0<x<2) treated with the fluorine-containing material and with heat-treatment, it was found that the latter battery showed much better cycle performance than the former one. Accordingly, in order to improve the cycle performance of the battery using SiOₓ (0<x<2) as a negative active material, crystalline structure of SiOₓ (0<x<2) has to be defined as mentioned above. However, this has not been derived from any known example.

In the negative active material of this invention, a variety of elements such as B, C, N, P, F, Cl, Br, I, Li, Na, Mg, Al, K, Ca, Zn, Ga, Ge, Sc, Ti, V, Cr, Mn, Fe, Co, Ni, and Cu may be incorporated.

As a positive active material of non-aqueous electrolyte battery of this invention, transition-metal oxide such as MnO₂ and V₂O₅, transition-metal carcogenide such as FeS and TiS₂, lithium-containing material with orivine-type structure such as LiM1ₓM2₁₋ₓPO₄ (M1 and M2 are selected from a group of Fe, Co, and Mn), and lithium-transition metal oxide can be used. As the lithium-transition metal oxide, LiₓM3_{y}M4_{1-y}O₂ (M3 and M4 are selected from a group of Ti, V, Cr, Mn, Fe, Co, Ni, and Cu; y=0.5-1) and LiₓM5_{y}Mn_{2-y}O₄ (M5 is selected from a group of Ti, V, Cr, Fe, Co, Ni, and Cu; 0.9≦x≦1.1, 0.4≦y≦0.6) may be used. And, Al, P, B, and other representative nonmetal elements, representative metal elements can be incorporated in these compounds and oxides. Among those compounds described above, lithium cobaltate (LiCoO₂) and lithium-cobalt-nickel oxide (LiCoₓNi₁₋ₓO₂) are preferred. The reason is that a battery using these positive active materials shows high voltage, high energy density, and excellent cycle performance.

Negative electrode to be used for non-aqueous electrolyte battery of this invention is comprised of a layer containing a negative active material and of a current collector. The layer is, for example, prepared by follows; a negative active material and a binder is mixed in a solvent to be slurry, and then the slurry is spread on the current collector, and finally the current collector is dried. The layer may contain electrically-conductive material in addition to the negative active material.

For the negative active material used in the battery of this invention, a mixture of the negative active material of this invention and at least one kind of material selected from a group of metallic lithium and materials allowing to store and release lithium ion may be used. Examples of such materials to store and release lithium ion include carbon, oxides, Li₃₋ₚMₚN, where M is transition metal and 0≦p≦0.8, nitride, and lithium alloy. Examples of the carbon include graphitizable carbon such as cokes, mesocarbon microbead (MCMB), mesophase pitchi-based carbon fiber,and VGCF, non-graphitizable carbon such as materials from heating phenol resin or furfuryl alchohol resin, polyacrylonitrile-based carbon fiber, glassy carbon, graphitic material such as natural graphite, artificial graphite, graphatized meso carbon microbead, graphitized meso phase pitch-based carbon fiber, and graphite whisker, and a mixture of thereof. Examples of the lithium alloy include alloy of lithium and metals such as aluminum, zinc, bismuth, cadmium, antimony, silicon, lead, tin, gallium, and indium. Examples of the oxide include the oxides of the lithium alloys mentioned above.

A positive electrode to be used for non-aqueous electrolyte battery of this invention is comprised of a layer containing a positive active material and of a current collector. The layer is, for example, prepared by follows; a positive active material, an electrically-conductive material and a binder is mixed in a solvent to prepare slurry, and then the slurry is spread on the current collector, and finally the current collector is dried.

As electrically-conductive material to be used in the positive and negative electrodes, various kinds of carbon may be used. Examples of the carbon include graphite such as natural graphite and artificial graphite, carbon black such as acetylene black, and amorphous carbon such as needle cokes.

Examples of the binder to be used in the positive and negative electrodes include polyvinylidene fluoride (PVdF), hexafluoro propylene (HFP), polytetrafluoro ethylene(PTFE), styrene-butadiene rubber (SBR),nitrile-butadiene rubber (NBR), fluoroelastomer, polyvinyl acetate, polymethyl acrylate, polyethylene, nitrocellulose, derivative thereof, and a mixture thereof. The solvent to be used for mixing positive or negative active materials and a binder may be such non-aqueous solvent as N-methyl-pyrrolidone (NMP), dimethyl formamide (DMF), dimethyl acetamide, methyl ethyl keton (MEK), cyclohexanone, methyl acetate, methyl acrylate, diethyl triamine, N,N-dimethyl amino-propyl-amine, ethylene oxide, tetrahydro furan (THF). Water may be also used as the solvent to dissolve or disperse a binder Examples of the current collector for the positive and negative electrodes include iron, copper, aluminum, stainless steel, and nickel. The shape of these collectors may be sheet, porous, mesh, and lattice. As a separator for the non-aqueous electrolyte battery of this invention, a micro porous polymer membrane may be used. A material of the membrane may be nylon, cellulose acetate, nitro cellulose, polysulfone, poly acrylnytril, PVdF, and polyolefin such as polypropylene, polyethylene, and polybutene, and a mixture thereof. Among these polymers, a micro porous membrane of polyolefin is preferable. Further, a piled membrane of polyethylene and polypropylene may be also used.

Examples of the non-aqueous electrolyte to be used for non-aqueous electrolyte battery of this invention include non-aqueous electrolyte solution, solid polymer electrolyte, gel electrolyte, and inorganic solid electrolyte. Electrolyte may have pores. Non-aqueous electrolyte solution is comprised of a non-aqueous solvent and a solute.

Examples of the solvent to be used for the non-aqueous electrolyte include ethylene carbonate, propylene carbonate, dimethyl carbonate, diethyl carbonate, γ-butyrolactone, sulfolane, dimethyl sulfoxide, acetonitrile, dimetyl formamide, dimethyl acetamide, 1, 2-dimethoxyethane, 1, 2-diethoxyethane, tetrahydro furan, 2-methyltetrahydrofuran dioxolane, methylacetate, and a mixture thereof.

Examples of the solute to be used for the non-aqueous electrolyte include LiPF₆, LiBF₄, LiAsF₆, LiClO₄, LiSCN, LiI, LiCl, LiBr, LiCF₃CO₂, LiCF₃SO₃, LiN(SO₂CF₃)₂, LiN(SO₂CE₂CF₃)₂, LiN(COCF₃)₂ and LiN(COCF₂CF₃)₂, and a mixture thereof.

Examples of the solid polymer electrolyte to be used include materials prepared by adding the solute mentioned above to such polymers as polyethylene oxide, polypropylene oxide, polyethyleneimide, and a mixture thereof. A gel electrolyte prepared by adding the solvent and the solute mentioned above to these polymers may be also used for the non-aqueous electrolyte.

As solid inorganic electrolyte, crystalline and amorphous solid electrolyte may be used. The former electrolyte includes LiI, Li₃N, Li₁₊ₓMₓTi₂₋ₓ(PO₄)₃ (M=A1, Sc, Y, La), Li_{0.5-3x}R_{0.5+x}TiO₃ (R═La, Pr, Nd, Sm) and thio-LISICON such as Li₄₋ₓGe₁₋ₓPₓS₄, and the latter one includes the oxide glass such as LiI—Li₂O—B₂O₅ system and Li₂O—SiO₂ system, and sulfide glass such as LiI—Li₂S—B₂S₃ system, LiI—Li₂S—SiS₂ system, and Li₂S—SiS₂—Li₃PO₄ system.

For the improvement of the utilization of negative electrode, ethylenesulfide (ES), hydrogen fluoride, triazolecycle compound, fluorine-containing ester solvent, a complex of tetraethyl ammonium fluoride (TEAF), and hydrogen fluoride, their derivatives, and the gas such as CO₂, NO₂, CO, SO₂ may be added in the non-aqueous electrolyte mentioned above.

### EXAMPLES

### Example 1

SiO powder having average diameter of 8 μm was used. This material showed very broad peak by x-ray diffraction, indicating that its crystalline structure is amorphous. The amorphous SiO powder is thereafter represented by material (X). The material (x) was heat-treated at 870° C. under argon atmosphere for 6 hours. The product was subsequently soaked for 3 hours in a solution containing 0.1 mol hydro fluoric acid per 1 gram of the product. The solution was then filtrated to obtain a solid. The resulting solid was washed by a distilled water, and finally dried at 60° C. in air to prepare a negative active material of this invention (e1). The average particle diameter was measured by an equipment of particle size distribution (Shimazu, SALD2000J) using a refractive index of 2.00−0.05i.

Non-aqueous secondary battery using the negative active material (e1) was prepared.

First, 70 mass % of the negative active material (e1), 10 mass % of acetylene black as carbon (B), and 20 mass % of poly vinylidene fluoride (PVdF) were mixed in N-methyl-pyrrolidone (NMP) to obtain a paste. The paste was spread on a copper foil of 15 μm in thickness, which was then dried at 150° C. to evaporate NMP. The foregoing procedure was conducted on both sides of the foil, and the foil was finally pressed to prepare a negative electrode.

Then, 90 mass % of LiCoO₂, 5 mass % of acetylene black, and 5 mass % of PVdF were mixed in NMP to obtain a paste. The paste was spread on an aluminum foil of 20 μm in thickness, which was then dried at 150° C. to evaporate NMP. The foregoing procedure was conducted on both sides of the foil, and the foil was finally pressed to prepare a positive electrode.

The prepared positive and negative electrodes were wound with a separator therebetween of polyethylene having the thickness of 20 μm and the porosity of 40%. The resulting electrodes was inserted in a container having the height of 48 mm, the width of 30 mm, and the thickness of 4.2 mm to obtain a prismatic battery. Then, a non-aqueous electrolytic solution was injected into the battery to prepare a battery of this Example (E1). The non-aqueous electrolytic solution contained a 1:1 by volume mixture of ethylene carbonate and diethyl carbonate, and 1 mol /dm³ of LiPF₆ in the mixed solvent.

### Example 2

By using the same procedures as Example 1 except that material (X) was heat-treated at 900° C. under argon atmosphere, a negative active material of this invention (e2) and a battery of this Example (E2) were prepared.

### Example 3

By using the same procedures as Example 1 except that material (X) was heat-treated at 950° C. under argon atmosphere, a negative active material of this invention (e3) and a battery of this Example (E3) were prepared.

### Example 4

By using the same procedures as Example 1 except that material (X) was heat-treated at 1000° C. under argon atmosphere, a negative active material of this invention (e4) and a battery of this Example (E4) were prepared.

### Example 5

By using the same procedures as Example 1 except that material (X) was heat-treated at 1050° C. under argon atmosphere, a negative active material of this invention (e5) and a battery of this Example (E5) were prepared.

### Example 6

By using the same procedures as Example 1 except that material (X) was heat-treated at 1100° C. under argon atmosphere, a negative active material of this invention (e6) and a battery of this Example (E6) were prepared.

### Example 7

By using the same procedures as Example 1 except that material (X) was heat-treated at 1150° C. under argon atmosphere, a negative active material of this invention (e7) and a battery of this Example (E7) were prepared.

### Example 8

A battery of this Example 4 (E8) was prepared in the same manner as Example 1 except that acetylene black was not used.

### Example 9

Material (X) was heat-treated at 1000° C. for 6 hours under argon atmosphere. The product was not treated with hydrofluoric acid to prepare a negative active material of this invention (e9), and following procedures were same as Example 1 to prepare a battery of this Example battery (E9).

### Example 10

SiO having amorphous crystalline structure and average particle diameter of 15 μm was heat-treated at 1000° C. under argon atmosphere to prepare a negative active material of this invention (e10), and following procedures were same as Example 1 to prepare a battery of this Example (E10).

### Example 11

SiO having amorphous crystalline structure and average particle diameter of 6 μm was heat-treated at 1000° C. under argon atmosphere to prepare a negative active material of this invention (e11), and following procedures were same as Example 1 to prepare a battery of this Example (E11).

### Example 12

SiO having amorphous crystalline structure and average particle diameter of 4 μm was heat-treated at 1000° C. under argon atmosphere to prepare a negative active material of this invention (e12), and following procedures were same as Example 1 to prepare a battery of this Example (E12).

### Example 13

The negative active material (e4) was plated on its surface with Ni to prepare a negative active material of this invention (e13), and following procedures were same as Example 1 to prepare a battery of this Example (E13). The amount of Ni was 3% by mass against the total mass of the material (e13).

### Example 14

A negative active material of this invention (e14) and a battery of this Example (E14) were prepared in the same manner as Example 13 except that the amount of Ni was 5% by mass against the total mass of the material (e14).

### Example 15

A negative active material of this invention (e15) and a battery of this Example (E15) were prepared in the same manner as Example 13 except that the amount of Ni was 10% by mass against the total mass of the material (e15).

### Example 16

A negative active material of this invention (e16) and a battery of this Example (E16) were prepared in the same manner as Example 13 except that the amount of Ni was 20% by mass against the total mass of the material (e16).

### Example 17

A negative active material of this invention (e17) and a battery of this Example (E17) were prepared in the same manner as Example 13 except that the amount of Ni 25% by mass against the total mass of the material (e17).

### Example 18

A negative active material (e4) was attached with carbon on its surface by a mechanical milling method to prepare a negative active material of this invention (e18). The amount of the carbon was 3% by mass against the total mass of the negative active material (e18). X-ray diffraction showed that the value of d(002)for the carbon was 0.3360 nm. Following procedures were same as Example 1 to prepare a battery of this Example (E18).

### Example 19

A negative active material of this invention (e19) was prepared in the same manner as the material (e18) except that the amount of the carbon was 5% by mass against the total mass of the negative active material (e19), and following procedures were same as Example 1 to prepare a battery of this Example (E19).

### Example 20

A negative active material of this invention (e20) was prepared in the same manner as the material (e18) except that the amount of the carbon was 10% by mass against the total mass of the negative active material (e20), and following procedures were same as Example 1 to prepare a battery of this Example (E20).

### Example 21

A negative active material of this invention (e21) was prepared in the same manner as the material (e18) except that the amount of the carbon was 15% by mass against the total mass of the negative active material (e21), and following procedures were same as Example 1 to prepare a battery of this Example (E21).

### Example 22

A negative active material of this invention (e22) was prepared in the same manner as the material (e18) except that the amount of the carbon was 20% by mass against the total mass of the negative active material (e22), and following procedures were same as Example 1 to prepare a battery of this Example (E22).

### Example 23

A negative active material of this invention (e23) was prepared in the same manner as the material (e18) except that the amount of the carbon was 25% by mass against the total mass of the negative active material (e23), and following procedures were same as Example 1 to prepare a battery of this Example (E23).

### Example 24

A negative active material of this invention (e24) was prepared in the same manner as the material (e18) except that the amount of the carbon was 30% by mass against the total mass of the negative active material (e24), and following procedures were same as Example 1 to prepare a battery of this Example (E24).

### Example 25

A negative active material of this invention (e25) was prepared in the same manner as the material (e18) except that the amount of the carbon was 40% by mass against the total mass of the negative active material (e25), and following procedures were same as Example 1 to prepare a battery of this Example (E25).

### Example 26

A negative active material of this invention (e26) was prepared in the same manner as the material (e18) except that the amount of the carbon was 60% by mass against the total mass of the negative active material (e26), and following procedures were same as Example 1 to prepare a battery of this Example (E26).

### Example 27

A negative active material of this invention (e27) was prepared in the same manner as the material (e18) except that the amount of the carbon was 70% by mass against the total mass of the negative active material (e27), and following procedures were same as Example 1 to prepare a battery of this Example (E27).

### Example 28

A negative active material of this invention (e28) was prepared in the same manner as the material (e18) except that the value of d(002) for the carbon was 0.3700 nm, and following procedures were same as Example 1 to prepare a battery of this Example (E28).

### Example 29

Toluene gas was pyrolyzed at 1000° C. under argon atmosphere (CVD method) to deposit carbon on the surface of the negative active material (e4) to prepare a negative active material of this invention (e29). The amount of the carbon was 20% by mass against the total mass of the negative active material (e29). X-ray diffraction showed that the value of the d(002) for the carbon was 0.3450 nm. Following procedures were same as Example 1 to prepare a battery of this Example (E29).

### Example 30

Natural graphite powder having d(002) of 0.3357 nm and an average particle diameter of 3 μm was used as carbon (B). This powder and the negative active material (e4) was mixed in the mass ratio of 0.5:99.5, and then, 90 mass % of the mixture and 10 mass % of PVdF were mixed in NMP to prepare a paste. The paste was spread on the surface of a copper foil of 15 μm in thickness, which was, then, dried to evaporate NMP. The foregoing procedure was conducted on both sides of the foil, and the foil was finally pressed to prepare a negative electrode. Following procedures were same as Example 1 to prepare a battery of this Example (E30).

### Example 31

A battery of this Example (E31) was prepared in the same manner as Example 30 except that the mixed ratio of natural graphite powder and the negative active material (e4) was 1:99 by mass.

### Example 32

A battery of this Example (E32) was prepared in the same manner as Example 30 except that the mixed ratio of natural graphite powder and the negative active material (e4) was 10:90 by mass.

### Example 33

A battery of this Example (E33) was prepared in the same manner as Example 30 except that the mixed ratio of natural graphite powder and the negative active material (e4) was 30:70 by mass.

### Example 34

A battery of this Example (E34) was prepared in the same manner as Example 30 except that the mixed ratio of natural graphite powder and the negative active material (e4) was 40:60 by mass.

### Example 35

A battery of this Example (E35) was prepared in the same manner as Example 32 except that VGCF with 5 μm in the long-axis length was used instead of the natural graphite powder.

### Example 36

A battery of this Example (E36) was prepared in the same manner as Example 32 except that artificial graphite powder with average particle diameter of 3 μm was used instead of the natural graphite powder.

### Example 37

A battery of this Example (E37) was prepared in the same manner as Example 32 except that glassy carbon powder with average particle diameter of 3 μm was used instead of the natural graphite powder.

### Example 38

A battery of this Example (E38) was prepared in the same manner as Example 32 except that the negative active material (e1) was used instead of the negative active material (e4).

### Example 39

A battery of this Example (E39) was prepared in the same manner as Example 32 except that the negative active material (e13) was used instead of the negative active material (e4).

### Example 40

A battery of this Example (E40) was prepared in the same manner as Example 32 except that the negative active material (e29) was used instead of the negative active material (e4).

### Example 41

A negative active material of this invention (e41) was prepared in the same manner as the material (e18) except that the value of d(002) for the carbon was 0.3600 nm. Following procedures were same as Example 1 to prepare a battery of this Example (E41).

### Comparative Example 1

A comparative negative active material (r1) was prepared in the same manner as the material (e1) except that the material (X) was heat-treated at 830° C. under argon atmosphere, and following procedures were same as Example 1 to prepare a comparative battery (R1).

X-ray Diffractometry

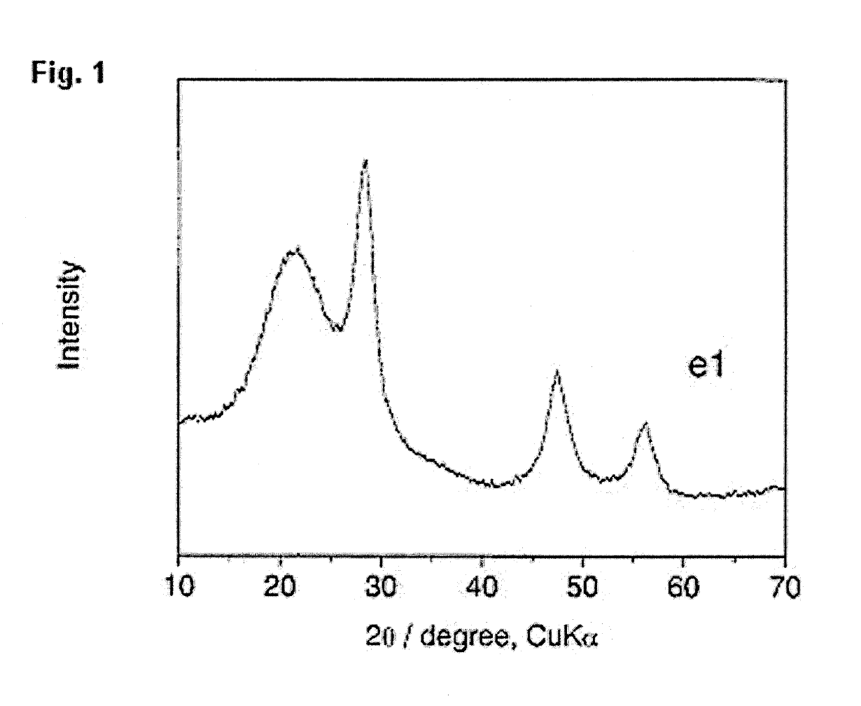

FIG. 1 shows x-ray diffraction pattern of the negative active material of this invention (e4). Clear peaks were observed at about 22 degree, 28 degree and 47 degree. The diffraction peaks at 28 degree and 47 degree are due to Si (111) plane and Si (220) plane, respectively. In addition, all negative active materials of this invention showed a relative intensity, I (220)/I (111), of less than 0.5. Furthermore, all negative active materials of this invention gave a peak due to Si (111) plane with full width at half maximum less than 3 degree. For the measurement, x-ray diffractometer (Rigaku, RINT2400) was used with setting the scattering-slit width and diffraction-slit width to be 1.0 degree, detector-slit width to be 0.15 mm, and scanning speed to be 1 degree/min.

Composition Analysis

XPS measurement revealed that the chemical formula in the surface of the negative active material (e9) was SiO_{1.55}, while that of all other negative active materials of this invention was SiO_{1.10}.

Transmission Electron Microscopy

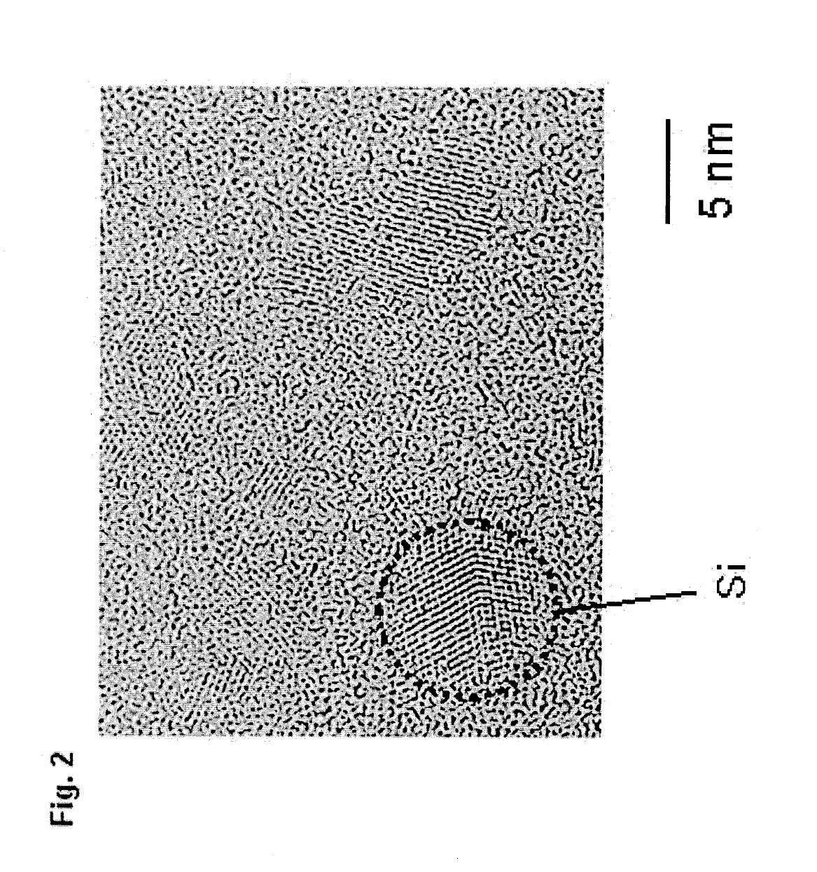

An observation by a transmission electron microscopy on the negative active materials (e3), (e4), (e5), (e6), (e7), (e9), (e10), (e11), (e12) revealed that silicon particles were finely dispersed in the individual particles of these active materials, and the diameter of the silicon particles were 3, 5, 10, 18, 30, 30, 30, 30, and 30 nm, respectively. FIG. 2 shows an image of a transmission electron microscope of the negative active material (e4) (the image is magnified by 4 million times). A silicon particle is enclosed by a dotted line, and a lattice lined in parallel was clearly seen in the particle. The surrounding of the silicon particle is mainly silicon oxide.

Charge-Discharge Measurement

The batteries mentioned above were charged at 25° C. with an electric current of 400 mA until the voltage of the battery reached 4.2 V, and subsequently the voltage was maintained at 4.2 V. The total charging time was set to be 2 hours. The batteries were then discharged with an electric current of 400 mA until the voltage of the battery reached 2.5 V. This operation is counted as one cycle. Charge-discharge measurement of 50 cycles was performed.

Table 1 shows the results of the charge-discharge test on the batteries of this Example and a comparative battery. In the Table, the full width at half maximum of a peak at around 47 degree (B) of SiOₓ (0<x<2) measured by x-ray diffraction, the mass ratio of electrically-conductive material attached on the surface of SiOₓ (0<x<2), the value of d(002) for the carbon as the electrically-conductive material, the mass ratio of carbon (B), the discharge capacity in the first cycle, and the capacity retention defined by the ratio of the discharge capacity in the first cycle against that in the 50th cycle.

TABLE 1

| | | ratio of | | | | |
|---|---|---|---|---|---|---|
| | | conductive | | | | |
| | B (degree, 2 | material (mass | d(002) | Carbon (B) | Discharge | |
| Battery | ∅) | %) | (nm) | (%) | capacity (mAh) | Capacity retention (%) |
| E1 | 2.7 | — | — | 10 | 400 | 50 |
| E2 | 2.4 | — | — | 10 | 400 | 52 |
| E3 | 2.2 | — | — | 10 | 400 | 58 |
| E4 | 1.7 | — | — | 10 | 400 | 60 |
| E5 | 1.3 | — | — | 10 | 400 | 59 |
| E6 | 0.9 | — | — | 10 | 400 | 58 |
| E7 | 0.7 | — | — | 10 | 400 | 47 |
| E8 | 1.7 | — | — | — | 100 | 45 |
| E9 | 1.7 | — | — | 10 | 220 | 51 |
| E10 | 1.7 | — | — | 10 | 400 | 47 |
| E11 | 1.7 | — | — | 10 | 400 | 62 |
| E12 | 1.7 | — | — | 10 | 400 | 68 |
| E13 | 1.7 | 3 | — | 10 | 402 | 62 |
| E14 | 1.7 | 5 | — | 10 | 409 | 69 |
| E15 | 1.7 | 10 | — | 10 | 422 | 72 |
| E16 | 1.7 | 20 | — | 10 | 415 | 72 |
| E17 | 1.7 | 25 | — | 10 | 380 | 73 |
| E18 | 1.7 | 3 | 0.3360 | 10 | 411 | 63 |
| E19 | 1.7 | 5 | 0.3360 | 10 | 419 | 69 |
| E20 | 1.7 | 10 | 0.3360 | 10 | 432 | 73 |
| E21 | 1.7 | 15 | 0.3360 | 10 | 451 | 73 |
| E22 | 1.7 | 20 | 0.3360 | 10 | 478 | 75 |
| E23 | 1.7 | 25 | 0.3360 | 10 | 457 | 76 |
| E24 | 1.7 | 30 | 0.3360 | 10 | 441 | 76 |
| E25 | 1.7 | 40 | 0.3360 | 10 | 422 | 77 |
| E26 | 1.7 | 60 | 0.3360 | 10 | 402 | 77 |
| E27 | 1.7 | 70 | 0.3360 | 10 | 375 | 79 |
| E28 | 1.7 | 3 | 0.3700 | 10 | 402 | 55 |
| E29 | 1.7 | 20 | 0.3450 | 10 | 470 | 85 |
| E30 | 1.7 | — | — | 0.5 | 270 | 51 |
| E31 | 1.7 | — | — | 1 | 332 | 56 |
| E32 | 1.7 | — | — | 10 | 385 | 58 |
| E33 | 1.7 | — | — | 30 | 360 | 65 |
| E34 | 1.7 | — | — | 40 | 313 | 72 |
| E35 | 1.7 | — | — | 10 | 390 | 65 |
| E36 | 1.7 | — | — | 10 | 385 | 55 |
| E37 | 1.7 | — | — | 10 | 341 | 44 |
| E38 | 2.7 | — | — | 10 | 385 | 50 |
| E39 | 1.7 | 3 | — | 10 | 389 | 60 |
| E40 | 1.7 | 20 | 0.3450 | 10 | 435 | 72 |
| E41 | 1.7 | 3 | 0.3600 | 10 | 405 | 61 |
| R1 | 3.1 | — | — | 10 | 400 | 20 |

Comparing a battery of this invention E1 and a comparative battery R1, the former battery having a negative active material with the value of B for Si(220) plane of less than 3 degree (2 θ) is found to show better cycle performance. Then, in terms of the cycle performance of the battery, the value of B for SiOₓ (0<x<2) to be used for a negative active material is required to be less than 3 degree (2 θ).

Comparing the batteries E1-E7, the cycle performance of the batteries was further improved when the value of B was 0.8<B<2.3 degrees (2 θ). Then, in terms of the cycle performance of the battery, B is preferably 0.8<B<2.3 degrees (2 θ). Comparing the batteries E4 and E9, the discharge capacity of the former battery is found to be larger than that of the latter one. The chemical formula in the surface of the negative active material used for E4 was SiO_{1.10} and that for E9 is SiO_{1.55}. Then, in terms of discharge capacity, the chemical formula in the surface of the negative active material of this invention is preferably SiOₓ (0<x<1.5). The battery E4 showed smaller polarization during charge than the battery E9. This is probably because the electronic conductivity of the negative active material in the former battery is higher than that in the latter one.

Comparing the batteries E4, E10, E11, and E12, the cycle performance of the batteries battery is found to be greatly improved when the average particle diameter of SiOₓ (0<x<2), r, is r<10 (μm), and to be more improved in case of r<5 (μm). Then, in terms of the cycle performance of the battery, the value of r (μm), is preferably r<10, and more preferably r<5.

Comparing the batteries E4, E13 and E18, the cycle performance of the batteries is much improved by using SiOₓ (0<x<2) having electrically-conductive material such as nickel and carbon on its surface. Then, in terms of the cycle performance of the battery, SiOₓ (0<x<2) having electrically-conductive material on its surface is preferable.

Comparing the batteries E13-E17, the cycle performance of the batteries is found to be much improved when the amount of Ni on the surface of SiOₓ (0<x<2) is not less than 5% by mass, while decreased when the amount of Ni is more than 20% by mass. Then, considering the cycle performance and the discharge capacity of the battery, the amount of electrically conductive material is preferably in the range of 5-20% by mass.

Comparing the batteries E13 and E 18, E14 and E19, E15 and E20, E16 and E21, and E17 and E22, respectively, that the batteries having SiOₓ (0<x<2) attached with carbon on its surface as electrically-conductive material is found to show larger discharge capacity than those with Ni instead of carbon. Then, in terms of the discharge capacity of the battery, electrically-conductive material attached on the surface of SiOₓ (0<x<2) is preferably carbon.

Comparing the batteries E18-E27, the cycle performance of the batteries is found to be remarkably improved when the amount of the carbon as electrically-conductive material on the surface of SiOₓ (0<x<2) was not less than 5% by mass. Furthermore, the discharge capacity is drastically improved when the amount of the carbon is in the range of 15-25% by mass. On the other hand, the amount of the carbon of more than 60% by mass results in the decrease of the discharge capacity of the batteries. Then in terms of the cycle performance and the discharge capacity of the battery, the amount of the carbon as electrically-conductive material on the surface of SiOₓ (0<x<2) is preferably in the range of 5-60% by mass, and more preferably 15-25% by mass.

Comparing the batteries E18, E28 and E41, the cycle performance of the batteries is found to be greatly improved when the value of d(002) for the carbon attached on the surface of SiOₓ (0<x<2) is not more than 0.3600 nm. Then, in terms of the cycle performance of the battery, the value of d(002) for the carbon on the surface of SiOₓ (0<x<2) is preferably not more than 0.3600 nm.

Comparing the batteries E8 and E4, and E8 and E30, respectively, the cycle performance of the batteries is found to be much improved by using a mixture of the negative active material of this invention and carbon (B) in the negative electrode. Thus, in terms of the cycle performance of the battery, a mixture of the negative active material of this invention and carbon (B) is preferably used in the negative electrode.

Comparing the batteries E1, E30-E34, the amount of carbon (B) of not less than 1% by mass is found to improve the cycle performance and increase the discharge capacity of the batteries. On the other hand, the amount of the carbon (B) of more than 30% by mass decreases the discharge capacity of the batteries. Then, in terms of the cycle performance and the discharge capacity of the battery, the amount of the carbon (B) to be used in the negative electrode of this invention is preferably in the range of 1-30% by mass.

Comparing the batteries E32, E35 and E36, the use of VGCF, rather than natural graphite powder and artificial graphite powder, improves greatly the cycle performance of the batteries. This is probably because the electrically-conductive network between the negative active material and VGCF is sufficiently maintained even if a large volume change of the negative active material is occurred during charge and discharge. Furthermore, comparing these batteries and the battery E37, the use of natural graphite powder, artificial graphite and VGCF, rather than glassy carbon, is found to give better cycle performance of the batteries.

The batteries of this invention were disassembled after charge-discharge test to obtain negative active materials. The negative active materials were then subjected to x-ray diffraction. It was found that the intensities of the diffraction peaks at about 28 degree and 47 degree were extremely smaller than those for the negative active materials before being assembled into the batteries. The full width at half maximum of each peak was not less than 3 degree. Then, It is found that charge and discharge of the battery of this invention changes the crystallinity of silicon in the negative active material of this invention to be amorphous.

These examples used Ni or carbon as electrically-conductive material attached on the surface of SiOₓ (0<x<2). The use of the other electrically-conductive materials such as Cu and Fe resulted in also superior cycle performance of the battery.

As mentioned above, a non-aqueous electrolyte battery using a negative active material which is characterized by comprising Si and O at the atomic ratio of O to Si, x, being 0<x<2, and by showing the full width at half maximum of Si(220) plane peak, B, being B<3 degree (2 θ) at x-ray diffraction with CuKα radiation shows better cycle performance.

What is claimed is:

1. A negative active material comprising Si and O at the atomic ratio of O to Si, x, being 0<x<2, and showing a full width at half maximum of Si(220) plane peak, B, being B<3 degree (2 θ) at x-ray diffraction with CuKα radiation.

2. The negative active material according to claim 1, wherein said negative active material being attached with electrically-conductive material on the surface.

3. The negative active material according to claim 2, wherein said electrically-conductive material is carbon (A).

4. A negative electrode comprising a mixture of said negative active material according to claim 1, 2 or 3 and of carbon (B).

5. The negative electrode according to claim 4, wherein the amount of carbon (B) against the total mass of said negative active material and of carbon (B) is not less than 1% by mass and not more than 30% by mass.

6. A method for preparing said negative active material according to claim 1 comprising the step of:
heating a material comprising Si and O at the atomic ratio of O to Si, x, being 0<x<2,at a temperature of higher than 830° C. under non-oxidizing atmosphere or reduced pressure.

7. A non-aqueous electrolyte battery comprising:
a positive electrode using a positive active material which can store and release lithium ion, and
a negative electrode using said negative active material according to claims 1, 2 or 3, or using said negative electrode according to claim 5.

8. A non-aqueous electrolyte battery comprising:
a positive electrode using a positive active material which can store and release lithium ion, and
said negative electrode according to claim 4.
